(19) United States
(12) Patent Application Publication
(10) Pub. No.: US 2009/0248215 A1
(43) Pub. Date: Oct. 1, 2009

(54) CONTROL DEVICE AND ELECTRIC POWER ESTIMATING METHOD

(75) Inventors: Masato Tanaka, Tokyo (JP); Hirofumi Hirayama, Tokyo (JP)

Correspondence Address: DARBY & DARBY P.C., P.O. BOX 770, Church Street Station, New York, NY, 10008-0770, US

(73) Assignee: Yamatake Corporation, Tokyo (JP)

(21) Appl. No.: 12/406,213

(22) Filed: Mar. 18, 2009

(30) Foreign Application Priority Data
Mar. 25, 2008 (JP) 2008-077658

(51) Int. Cl. G06F 1/28

(52) U.S. Cl. 700/291; 700/42

(57) ABSTRACT

To estimate the instantaneous electric power consumption of an actuator, such as a heater, with excellent accuracy, while using an existing structure. A control device comprises a PID control calculating unit for calculating, and for outputting to the actuator, an manipulated variable MV based on a produced variable PV of an object to be controlled; and an electric power estimating unit for estimating the electric power consumption of the actuator using an electric power estimating function equation that has been set in advance, using, as input variables, the manipulated variable MV, the produced variable PV, and an electric current value CT of the electric current that flows through the actuator in response to the output of the manipulated variable MV. The electric power estimating function equation is derived in advance through multivariate analysis from actual measured data from the input variables and actual measured data for the electric power consumption of the actuator.

### CROSS REFERENCE TO PRIOR APPLICATION

The present application claims priority under U.S.C. §119 to Japanese Patent Application No. 2008-077658, filed Mar. 25, 2008. The content of the application is incorporated herein by reference in its entirety.

### FIELD OF TECHNOLOGY

The present invention relates to a control device such as a temperature controller, and in particular, relates to a control device and an electric power estimating method for estimating electric power consumption of an actuator, such as a heater.

### BACKGROUND OF THE INVENTION

Given desires to conserve energy in recent years, there are now demands for functions for monitoring electric power used in control devices as well, and for controlling the electric power. Given this, in, for example, the air-conditioning/heating device disclosed in Japanese unexamined Patent Application Publication 2004-085087 (“JP '087”), the electric energy consumption of a heater is estimated based on the time of operation of the heater and the electric power consumed by the heater per unit time.

However, in temperature control devices with simple structures, such as temperature controllers, the addition of a function for measuring the electric power consumption per unit time by the heater would give rise to greater complexity in the structure and to increased costs, and thus it is difficult to add a new function for measuring the electric power. Additionally, it is not possible to add a measuring function of this type to existing temperature controllers.

Given this, one may consider methods for estimating the instantaneous electric power consumption by a heater using an existing structure. In the case of an electric heater, there are sometimes failures such as the heater burning out, and thus in a temperature control device such as a temperature controller the electric current value CT (Current Transformer value) for the electric current that flows through the heater is measured to monitor for the heater burning out. The use of this electric current value CT makes it possible to estimate the instantaneous electric power consumption of the heater. Additionally, in a temperature control device such as a temperature controller, an manipulated variable MV is calculated as a value that is outputted to an electric power regulating device. The use of this manipulated variable MV makes it possible to estimate the instantaneous electric power consumption of the heater.

As described above, one may consider estimating the instantaneous electric power consumption of the heater from the electric current value CT and the manipulated variable MV. However, while the electric current value CT is a numeric value that is highly correlated with the amount of electric power used, it has inadequate accuracy as a substitute for an adequate electric power estimate value, depending on the application, and thus there are limitations on the use of the electric current value CT in estimating the electric power. The reasons for this is that there is a temperature dependency in the resistance of the heater, and there are non-linear characteristics in the electric power regulator that supplies the electric power to the heater depending on the manipulated variable MV.

Note that problems such as described above are not limited to temperature controllers, but rather occurred in the same way in control devices wherein it is difficult to add an electric power measuring function.

### SUMMARY OF THE INVENTION

The present invention was created in order to resolve the problems set forth above, and the object thereof is to provide a control device and an electric power estimating method that can estimate, with excellent accuracy, the instantaneous electric power consumption of an actuator, such as a heater, while using an existing structure.

The control device according to the present invention includes: control calculating means for calculating, and outputting to an actuator, an manipulated variable MV based on a produced variable PV to be controlled; and electric power estimating means for estimating electric power consumption of the actuator using an electric power estimating function equation established in advance, having, as input variables, the produced variable PV and an electric current value CT for the electric current that flows through the actuator in accordance with the electric power of the manipulated variable MV.

Additionally, in one structural example of the control device according to the present invention, the electric power estimating means estimate the electric power consumption of the actuator with the manipulated variable MV as an input variable in addition to the electric current value CT and the produced variable PV.

Additionally, the control device according to the present invention includes: control calculating means for calculating, and outputting to an actuator, an manipulated variable MV based on a produced variable PV to be controlled; and electric power estimating means for estimating the electric power consumption of the actuator using an electric power estimating function equation established in advance, having, as input variables, the manipulated variable MV and the produced variable PV.

Additionally, in one structural example of the control device according to the present invention, the electric power estimating function equation is derived in advance through multivariate analysis from actual measured data for power consumption of the actuator and actual measured data for the input variables.

Additionally, the electric power estimating method according to the present invention has a control calculating step for calculating, and outputting to an actuator, an manipulated variable MV based on a produced variable PV to be controlled; and an electric power estimating step for estimating electric power consumption of the actuator using an electric power estimating function equation established in advance, having, as input variables, the produced variable PV and an electric current value CT for the electric current that flows through the actuator in accordance with the electric power of the manipulated variable MV.

Additionally, in one structural example of the electric power estimating method according to the present invention, the electric power estimating step estimates the electric power consumption of the actuator with the manipulated variable MV as an input variable in addition to the electric current value CT and the produced variable PV.

Additionally, the electric power estimating method according to the present invention includes a control calculating step for calculating, and outputting to an actuator, an manipulated variable MV based on a produced variable PV to be controlled; and an electric power estimating step for estimating the electric power consumption of the actuator using an electric power estimating function equation established in advance, having, as input variables, the manipulated variable MV and the produced variable PV.

The present invention enables the estimation of the instantaneous electric power consumption of the actuator, with excellent accuracy, while using an existing structure for the control device, through estimating the electric power consumption of an actuator through an electric power estimating function equation using, as the input variables, the produced variable PV and the electric current value CT of the electric current flowing in the actuator.

Additionally, the present invention enables the estimation of the instantaneous electric power consumption of the actuator with even better accuracy through estimating the electric power consumption of the actuator using the manipulated variable MV as an input variable in addition to the electric current value CT and the produced variable PV.

Furthermore, the present invention enables the estimation of the instantaneous electric power consumption of the actuator with excellent accuracy, while using the existing structure of the control device, through estimating the electric power consumption of the actuator through an electric power estimating function equation with the manipulated variable MV and the produced variable PV as input variables. Furthermore, in the present invention the instantaneous electric power consumption of the actuator can be estimated without measuring the electric current value CT, and thus the present invention can be applied also to control devices that are not provided with electric current measuring means.

### BRIEF DESCRIPTION OF THE DRAWINGS

FIG. 1 is a block diagram illustrating the structure of a control device according to an embodiment according to the present invention.

FIG. 2 is a diagram illustrating one example of a temperature control system wherein the control device according to the embodiment according to the present invention is applied.

FIG. 3 is a flowchart illustrating the operation of the control device according to the embodiment according to the present invention.

FIG. 4 is a diagram illustrating the results of a comparison of the electric power measured values and the electric power estimate values in the embodiment according to the present invention.

FIG. 5 is a block diagram illustrating the structure of a control device according to another embodiment according to the present invention.

FIG. 6 is a flowchart illustrating the operation of the control device according to the other embodiment according to the present invention.

FIG. 7 is a diagram illustrating the results of a comparison of the electric power measured values to the electric power estimate values in the other embodiment according to the present invention.

### DETAILED DESCRIPTION OF THE INVENTION

When the electric current value CT for the electric current flowing through the heater is used in estimating the instantaneous electric power consumption of the heater, factors that have an impact on the accuracy of the electric current estimation value include the temperature dependency of the heater resistance, and non-linear characteristics of the electric power regulating device. While these are not the only factors that have an impact on the accuracy, in a temperature controller, the produced variable PV can be obtained as a temperature measurement value, and the operating value of MV can be obtained as an output value to the electric power regulating device. Consequently, the inventors observed that, for the change in the heater resistance due to temperature, the estimate can be corrected using the produced variable PV, and for the non-linear characteristics of the electric power regulating device, the estimate can be corrected using the manipulated variable MV. Additionally, the inventors realized that implementing, in the temperature controller, an electric power estimating function equation that uses the electric current value CT, the manipulated variable MV, and the produced variable PV as the input variables (independent variables) of the electric power estimating function, and uses an electric power estimate value as the output variable (the dependent variable), would be useful in solving the problem. As a specific strategy, the relationship between measurement results of instantaneous electric power consumption of a heater, measured using an electric power measuring device, and the measurement results of the electric current value CT, the manipulated variable MV, and the produced variable PV should be researched in advance to derive in advance the coefficient values for the electric power estimating function equation through the use of a multivariate analysis method, or the like, to establish, in the temperature controller, an electric power estimating function equation for which the coefficient values have been determined.

When the manipulated variable MV, which is the output value to the electric power regulating device, is used in estimating the instantaneous power consumption of the heater, factors that have an impact on the accuracy of the electric power estimation value include the temperature dependency of the heater resistance. While this is not the only factor that has an impact on the accuracy, in a temperature controller, the produced variable PV can be obtained as a temperature measurement value. Consequently, the inventors observed that, for the change in heater resistance due to temperature, the estimate can be corrected using the produced variable PV. Additionally, the inventors observed that the provision, in a temperature controller, of an electric power estimating function that uses the manipulated variable MV and the produced variable PV as input variables for the electric power estimating function and that uses the electric power estimate value as the output variable would be useful in solving the problem. As a specific strategy, the relationship between measurement results for the instantaneous electric power consumption of the heater, using an electric power measuring device, and the measurement results for the manipulated variable MV and the produced variable PV, should be researched in advance to derive in advance the coefficient values for the electric power estimating function equation through the use of a multivariate analysis method, or the like, to establish, in the temperature controller, an electric power estimating function equation for which the coefficient values have been determined.

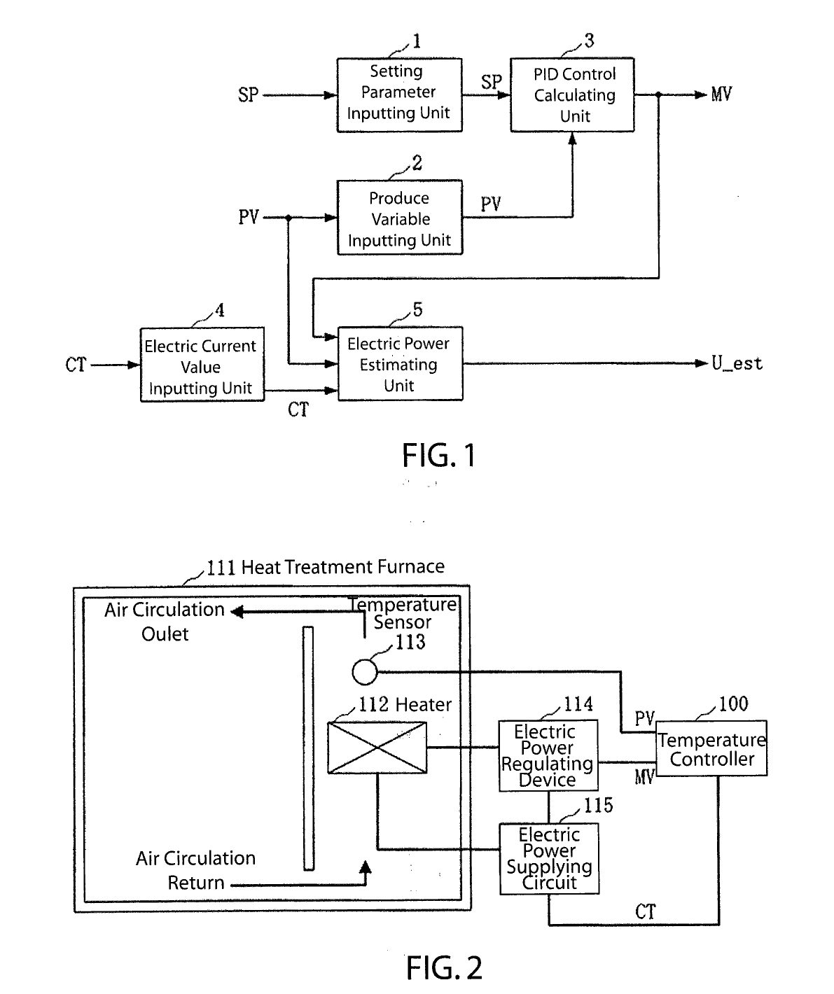

An embodiment according to the present invention will be explained below in reference to the drawings. FIG. 1 is a block diagram illustrating the structure of a control device according to an embodiment according to the present invention. The principles in the embodiment corresponds to the description of the Invention, set forth above.

The control device has a setting parameter inputting unit 1, a produced variable inputting unit 2, a PID control calculating unit 3, an electric current value inputting unit 4, and an electric power estimating unit 5.

FIG. 2 is a diagram illustrating one example of a temperature control system to which is applied the control device of the present form of embodiment. In the example in FIG. 2, a heater 112 and a temperature sensor 113 are disposed within a heat treatment furnace 111. The temperature sensor 113 measures the temperature PV of the air that is heated by the heater 112. The temperature controller 100 calculates the manipulated variable MV so as to cause the temperature PV to match the setting parameter SP. An electric power regulating device 114 determines the electric power in accordance with the manipulated variable MV, and supplies the determined amount of electric power through an electric power supplying circuit 115 to the heater 112. In this way, the temperature controller 100 controls the temperature within the heat treatment furnace 111. The control device in the present form of embodiment is provided within the temperature controller 100. The electric power regulating device 114, the electric power supplying circuit 115, and the heater 112 structure the actuator for controlling the object to be controlled (the heat treatment furnace 111). The electric power supplying circuit 115 is provided with an electric current measuring unit (not shown) for measuring the electric current value CT of the electric current that flows in the heater 112.

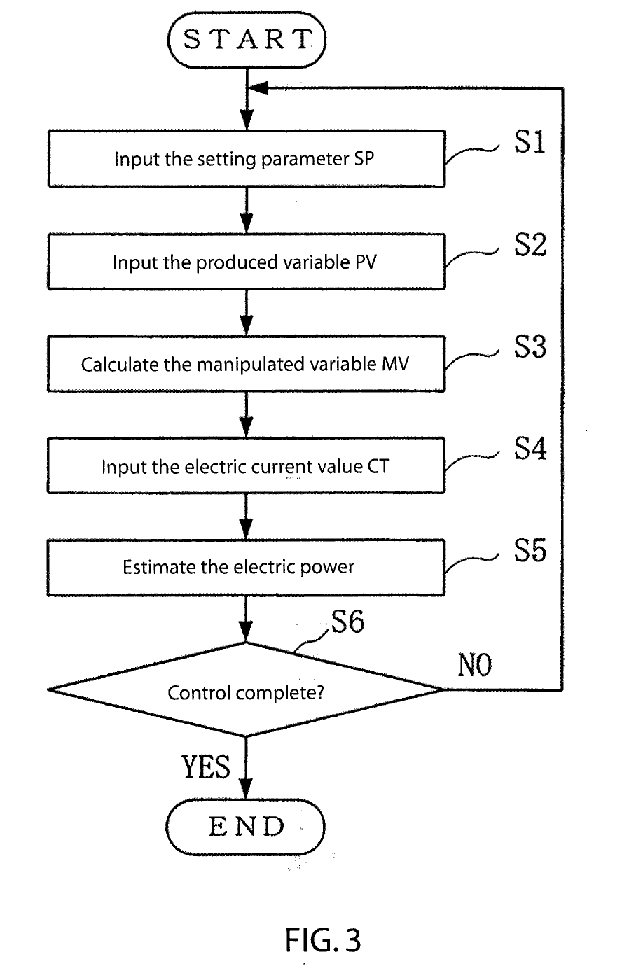

The operation of the control device in the present form of embodiment will be explained below. FIG. 3 is a flowchart illustrating the operation of the control device.

The setting parameter SP is set by the operator of the control device, and is inputted into the PID control calculating unit 3 through the setting parameter inputting unit 1. (Step S1 in FIG. 3)

The produced variable PV is detected by a sensor (the temperature sensor 113 in the example in FIG. 2), and is inputted into the PID control calculating unit 3 and the electric power estimating unit 5 through the produced variable inputting unit 2. (Step S2)

Following this, the PID control calculating unit 3 performs known PID control calculations based on the setting parameter SP that has been inputted through the setting parameter inputting unit 1, and the produced variable PV that has been inputted through the produced variable inputting unit 2. The manipulated variable MV is calculated so as to cause the setting parameter SP and the produced variable PV to match. (Step S3) Additionally, the PID control calculating unit 3 outputs the calculated manipulated variable MV to the object to be controlled and to the electric power estimating unit 5. While, in the example in FIG. 2, the object to be controlled is a heat treatment furnace 111, the actual destination for the manipulated variable MV is, of course, the electric power regulating device 114.

Next an electric current is produced in the heater 112 in accordance with the manipulated variable MV. At this time, the electric current value CT is measured by the electric current measuring unit within the electric current supplying circuit 115, and is inputted into the electric power estimating unit 5 through the electric current value inputting unit 4. (Step S4)

The electric power estimating unit 5 uses an electric power estimating function F, which has been set in advance, to calculate the instantaneous electric power consumption estimate value U_est of the heater 112 from the electric current value CT, the manipulated variable MV, and the produced variable PV, as in the following formula. (Step S5)

U_est=F(CT, MV, PV) (1)

The processes in Step S1 through S5, as described above, are performed repetitively for each control cycle until there is an instruction from the operator to terminate the control. (Yes in Step S6)

The method for deriving the electric power estimating function F will be explained next. The input/output relationships between the electric current value CT [A], the manipulated variable MV [%], the produced variable PV [° C.], and the electric power measured value U [W], analyzed for an actual controlled object, are expressed in the formula below:

CT=0.01×MV−0.0001×(PV−200.0) (2)

U=CT×CT×200.0×(1.0+0.0125×MV)×(1.0+0.001×PV) (3)

Equation (2) and Equation (3) do not express, as is, the input/output relationship in the actual object to be controlled, but are estimated from the results of analysis of the actual object to be controlled in the state where the electric power measured value U is obtained based on specific relationships such as in Equation (2) and Equation (3), and is no more than a description of a single case for understanding the input/output relationships. At this time, data such as in Table 1 can be collected from Equation (2) and Equation (3) (where this is hypothetical data to facilitate the explanation).

TABLE 1
Collected Data

| CT | MV | PV | U |
|---|---|---|---|
| 0.1 | 10 | 200 | 2.7 |
| 0.09 | 10 | 300 | 2.36925 |
| 0.08 | 10 | 400 | 2.016 |
| 0.07 | 10 | 500 | 1.65375 |
| 0.06 | 10 | 600 | 1.296 |
| 0.05 | 10 | 700 | 0.95625 |
| 0.04 | 10 | 800 | 0.648 |
| 0.3 | 30 | 200 | 29.7 |
| 0.29 | 30 | 300 | 30.06575 |
| 0.28 | 30 | 400 | 30.184 |
| 0.27 | 30 | 500 | 30.07125 |
| 0.26 | 30 | 600 | 29744 |
| 0.25 | 30 | 700 | 29.21875 |
| 0.24 | 30 | 800 | 28.512 |
| 0.5 | 50 | 200 | 97.5 |
| 0.49 | 50 | 300 | 101.4423 |
| 0.48 | 50 | 400 | 104.832 |
| 0.47 | 50 | 500 | 107.6888 |
| 0.46 | 50 | 600 | 110.032 |
| 0.45 | 50 | 700 | 111.8813 |
| 0.44 | 50 | 800 | 113.256 |
| 0.7 | 70 | 200 | 220.5 |
| 0.69 | 70 | 300 | 232.0988 |
| 0.68 | 70 | 400 | 242.76 |
| 0.67 | 70 | 500 | 252.5063 |
| 0.66 | 70 | 600 | 261.36 |
| 0.65 | 70 | 700 | 269.3438 |
| 0.64 | 70 | 800 | 276.48 |
| 0.9 | 90 | 200 | 413.1 |
| 0.89 | 90 | 300 | 437.6353 |
| 0.88 | 90 | 400 | 460.768 |
| 0.87 | 90 | 500 | 482.5238 |
| 0.86 | 90 | 600 | 502.928 |
| 0.85 | 90 | 700 | 522.0063 |
| 0.84 | 90 | 800 | 539.784 |

The input/output relationship for the object to be controlled is identified using the multivariate analysis method using the data that has been collected. In the present form of embodiment the use of a method that uses the fuzzy quantification theory 2, shown for the on-line processing unit in Japanese Unexamined Patent Application Publication H5-141999 and Japanese Unexamined Patent Application Publication H6-332504 will be explained.

When the method that uses the fuzzy quantification theory 2 is applied to the data of Table 1, an electric power estimating function equation such as shown below is obtained. Note that here a fourth-order approximation is used.

$$\begin{matrix}S = - 0.196013 - 3.282893 \times CT + 0.038556 \times MV - 0.000291 \times PV & ( 4 ) \\ U\_est = 62.748737 + 627.430661 \times S + 3651.138842 \times {S}^{2} + 5845.650790 \times {S}^{3} - 27793.31239 \times S 4 & ( 5 )\end{matrix}$$

Table 2 shows the data of Table 1, collected in advance, and the electric power estimate value U_est obtained when the Table 1 electric current value CT, manipulated variable MV, and produced variable PV were inputted into the electric power estimating function equations of Equation (4) and Equation (5). Additionally, while Table 2 is a comparison using the data gathered for producing the formula, Table 3 shows other data that was collected separately for validating the formula (other hypothetical data obtained from Equation (2) and Equation (3)), and the electric power estimate values U_est obtained when this data was inputted into the electric power estimating function equation.

TABLE 2
Elected Data and Electric Power Estimate Values

| CT | MV | PV | U | U_est |
|---|---|---|---|---|
| 0.1 | 10 | 200 | 2.7 | −5.66932 |
| 0.09 | 10 | 300 | 2.36925 | −3.07506 |
| 0.08 | 10 | 400 | 2.016 | −0.64663 |
| 0.07 | 10 | 500 | 1.65375 | 1.624409 |
| 0.06 | 10 | 600 | 1.296 | 3.746361 |
| 0.05 | 10 | 700 | 0.95625 | 5.727407 |
| 0.04 | 10 | 800 | 0.648 | 7.575595 |
| 0.3 | 30 | 200 | 29.7 | 31.28682 |
| 0.29 | 30 | 300 | 30.06575 | 32.07438 |
| 0.28 | 30 | 400 | 30.184 | 32.8964 |
| 0.27 | 30 | 500 | 30.07125 | 33.75735 |
| 0.26 | 30 | 600 | 29.744 | 34.66157 |
| 0.25 | 30 | 700 | 29.21875 | 35.61329 |
| 0.24 | 30 | 800 | 28.512 | 36.61658 |
| 0.5 | 50 | 200 | 97.5 | 86.85077 |
| 0.49 | 50 | 300 | 101.4423 | 90.1757 |
| 0.48 | 50 | 400 | 104.832 | 93.61369 |
| 0.47 | 50 | 500 | 107.6888 | 97.16524 |
| 0.46 | 50 | 600 | 110.032 | 100.8307 |
| 0.45 | 50 | 700 | 111.8813 | 104.6105 |
| 0.44 | 50 | 800 | 113.256 | 108.5045 |
| 0.7 | 70 | 200 | 220.5 | 238.9203 |
| 0.69 | 70 | 300 | 232.0988 | 245.3888 |
| 0.68 | 70 | 400 | 242.76 | 251.9273 |
| 0.67 | 70 | 500 | 252.5063 | 258.5323 |
| 0.66 | 70 | 600 | 261.36 | 265.2002 |
| 0.65 | 70 | 700 | 269.3438 | 271.9274 |
| 0.64 | 70 | 800 | 276.48 | 278.71 |
| 0.9 | 90 | 200 | 413.1 | 450.5775 |
| 0.89 | 90 | 300 | 437.6353 | 457.0579 |
| 0.88 | 90 | 400 | 460.768 | 463.4435 |
| 0.87 | 90 | 500 | 482.5238 | 469.727 |
| 0.86 | 90 | 600 | 502.928 | 475.9006 |
| 0.85 | 90 | 700 | 522.0063 | 481.9569 |
| 0.84 | 90 | 800 | 539.784 | 487.8879 |

TABLE 3
Formula Validation Data and Electric Power Estimate Values

| CT | MV | PV | U | U_est |
|---|---|---|---|---|
| 0.2 | 20 | 200 | 12 | 19.83638 |
| 0.19 | 20 | 300 | 11.7325 | 20.75066 |
| 0.18 | 20 | 400 | 11.34 | 2161447 |
| 0.17 | 20 | 500 | 108375 | 22.43426 |
| 0.16 | 20 | 600 | 10.24 | 23.21636 |
| 0.15 | 20 | 700 | 9.5625 | 23.96696 |
| 0.14 | 20 | 800 | 8.82 | 24.69213 |
| 0.4 | 40 | 200 | 57.6 | 49.18321 |
| 0.39 | 40 | 300 | 59.319 | 50.93007 |
| 0.38 | 40 | 400 | 60.648 | 52.76589 |
| 0.37 | 40 | 500 | 61.605 | 54.69317 |
| 0.36 | 40 | 600 | 62.208 | 56.71427 |
| 0.35 | 40 | 700 | 62.475 | 58.83144 |
| 0.34 | 40 | 800 | 62.424 | 61.04677 |
| 0.6 | 60 | 200 | 151.2 | 150.4387 |
| 0.59 | 60 | 300 | 158.3855 | 155.4933 |
| 0.58 | 60 | 400 | 164.836 | 160.6546 |
| 0.57 | 60 | 500 | 170.5725 | 165.9211 |
| 0.56 | 60 | 600 | 175.616 | 171.2913 |
| 0.55 | 60 | 700 | 179.9875 | 176.7634 |
| 0.54 | 60 | 800 | 183.708 | 182.3356 |
| 0.8 | 80 | 200 | 307.2 | 344.0928 |
| 0.79 | 80 | 300 | 324.532 | 351.1923 |
| 0.78 | 80 | 400 | 340.704 | 358.2947 |
| 0.77 | 80 | 500 | 355.74 | 365.3944 |
| 0.76 | 80 | 600 | 369.664 | 372.4859 |
| 0.75 | 80 | 700 | 382.5 | 379.5635 |
| 0.74 | 80 | 800 | 394.272 | 386.6214 |

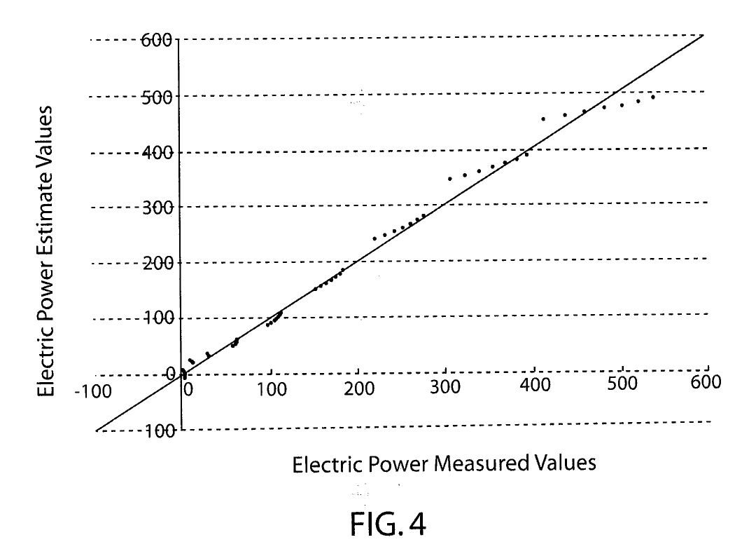

FIG. 4 shows a graph wherein the electric power measured values U, shown in Table 2 and Table 3 are graphed on the horizontal axis, and the electric power estimated values U_est are graphed on the vertical axis. While the collected data illustrated in Table 2 and Table 3 are hypothetical data for illustrating roughly the degree of accuracy that can be obtained for the electric power estimate values, it can be seen that the accuracy of the electric power estimate values is increased through using the electric current value CT, the manipulated variable MV, and the produced variable PV as input variables.

In the case of actually calculating an electric power estimating function equation, the electric current values CT, the manipulated variables MV, the produced variables PV, and the electric power measured values U are actually measured for the object to be measured, and with the electric current values CT, the manipulated variables MV, and the produced variables PV as input variables (independent variables) and the electric current estimate values U_est as output values (dependent variables), multivariate analysis may be performed using the actual measured data for the electric current values CT, the manipulated variables MV, and the produced variables PV, and the actual measured data for the electric power measured values U. Additionally, the calculated electric power estimating function equation may be set into the electric power estimating unit 5.

In this way, in the present form of embodiment, the electric power consumed by the heater is estimated by the electric power estimating function equation using the electric current value CT, the manipulated variable MV, and the produced variable PV as the input variables, enabling the temperature dependency of the heater resistance to be corrected by the produced variable PV and the non-linear characteristics of the electric power regulating device to be corrected by the manipulated variable MV, thus making it possible to estimate the instantaneous electric power consumption of the heater with excellent accuracy. Additionally, because in the present form of embodiment the produced variable PV is obtained using the existing temperature sensor that is provided in the control device and the electric current value CT is obtained using an existing electric current measuring unit, it is possible to estimate the instantaneous electric power consumption of the heater without adding any special equipment. Note that even though the electric current measuring unit is provided externally to the control device in the example in FIG. 2, the electric current measuring unit may be provided within the control device instead.

Additionally, while in the present form of embodiment the electric current value CT, the manipulated variable MV, and the produced variable PV were used as the input variables, in some cases the non-linearity that is dependent on the manipulated variable MV may be insignificant when compared to the non-linearity that is dependent on the produced variable PV in the electric power estimation. Consequently, it is possible to improve, to a practical level, the electric power estimating accuracy by adding only the corrections through the produced variable PV to the electric power estimate by the electric current value CT alone. In this case, the electric current values CT, the produced variables PV, and the electric power measurement values U may be actually measured for the object to be measured, and with the electric current value CT and the produced variable PV as the input variables and the electric power estimate values U_est as the output variable, multivariate analysis may be performed using the actual data for the electric current values CT and the produced variables PV, and the actual measured data for the electric power measured values U. Additionally, the calculated electric current estimating function equation may be set in the electric power estimating unit 5. Doing so enables the electric power estimating unit 5 to calculate an instantaneous electric power consumption estimate value from an electric current value CT and a produced variable PV.

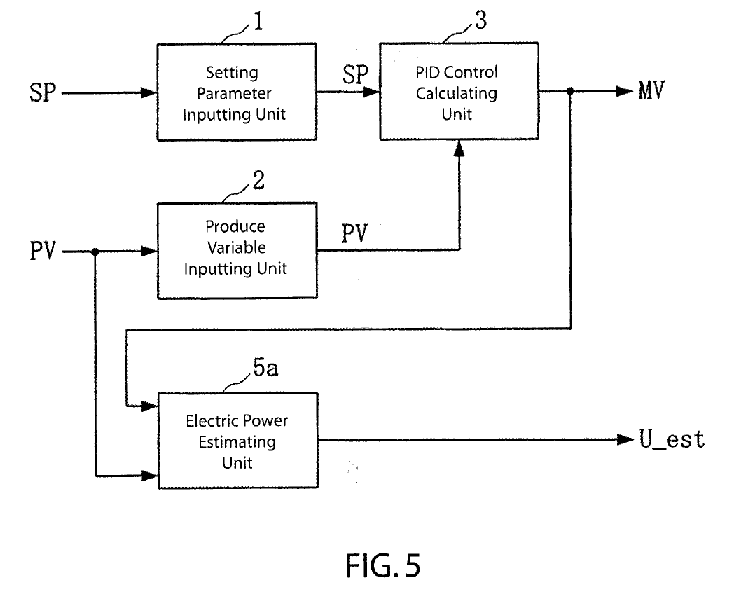

Another embodiment according to the present invention will be explained next. FIG. 5 is a block diagram illustrating the structure of a control device according to this embodiment according to the present invention, where those structures that are identical to those in FIG. 1 are given identical codes. The principles of the present embodiment correspond to the description of the Invention set forth above.

The control device has a setting parameter inputting unit 1, a produced variable inputting unit 2, a PID control calculating unit 3, and an electric power estimating unit 5a.

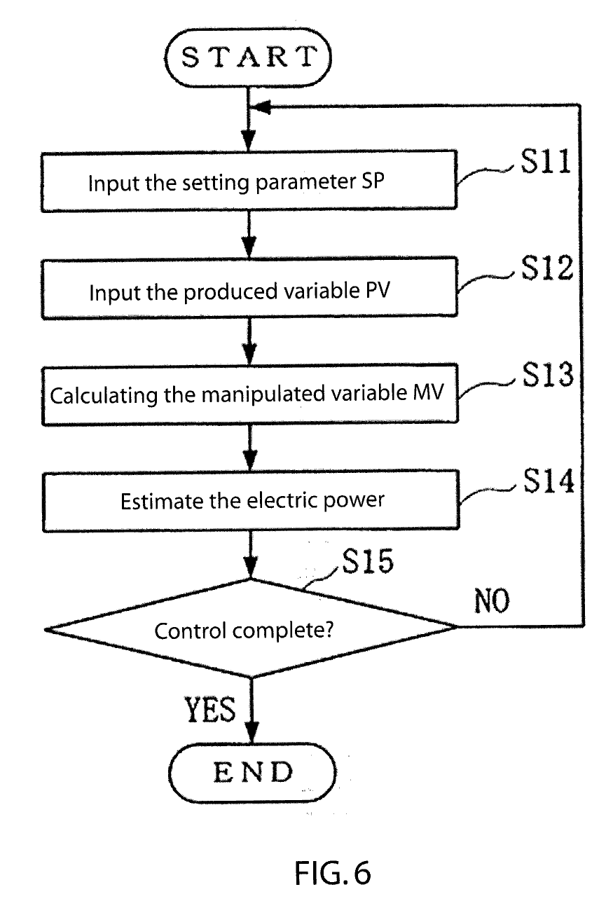

The operation of the control device in the present form of embodiment will be explained below. FIG. 6 is a flowchart illustrating the operation of the control device.

The processes in Step S11, S12, and S13 of FIG. 6 are identical to those in Step S1, S2, and S3 in FIG. 3.

The electric power estimating unit 5a uses the electric power estimating function F, which has been set in advance, to calculate the instantaneous electric power consumption estimate value U_est of the heater 112 from the manipulated variable MV and the produced variable PV, as in the following equation. (Step S14):

U_est=F(MV, PV) (6)

The processes in Step S11 through S14, as described above, are performed repetitively for each control cycle until there is an instruction from the operator to terminate the control. (Yes in Step S15)

The processes in Step S11 through S14, as described above, are performed repetitively for each control cycle until there is an instruction from the operator to terminate the control. (Yes in Step S15)

The method for deriving the electric power estimating function F will be explained next. The method for deriving the electric power estimating function F will be explained next. The input/output relationships between the manipulated variable MV [%], the produced variable PV [° C.], and the electric power measured value U [W], analyzed for an actual controlled object, are expressed in the formula below:

X=0.01×MV−0.0001×(PV−200.0) (7)

U=X×X×200.0×(1.0+0.0125×MV)×(1.0+0.001×PV) (8)

Equation (7) and Equation (8) do not express, as is, the input/output relationship in the actual object to be controlled, but are estimated from the results of analysis of the actual object to be controlled in the state where the electric power measured value U is obtained based on specific relationships such as in Equation (7) and Equation (8), and is no more than a description of a single case for understanding the input/output relationships. At this time, hypothetical data such as in Table 4 can be collected from Equation (7) and Equation (8).

TABLE 4

| MV | PV | U |
|---|---|---|
| 10 | 200 | 2.7 |
| 10 | 300 | 2.36925 |
| 10 | 400 | 2.016 |
| 10 | 500 | 1.65375 |
| 10 | 600 | 1.296 |
| 10 | 700 | 0.95625 |
| 10 | 800 | 0.648 |
| 30 | 200 | 29.7 |
| 30 | 300 | 30.06575 |
| 30 | 400 | 30.184 |
| 30 | 500 | 30.07125 |
| 30 | 600 | 29.144 |
| 30 | 700 | 29.21875 |
| 30 | 800 | 28.512 |
| 50 | 200 | 97.5 |
| 50 | 300 | 101.4423 |
| 50 | 400 | 104.832 |
| 50 | 500 | 107.6888 |
| 50 | 600 | 110.032 |
| 50 | 700 | 111.8813 |
| 50 | 800 | 113.256 |
| 70 | 200 | 220.5 |
| 70 | 300 | 232.0988 |
| 70 | 400 | 242.76 |
| 70 | 500 | 252.5063 |
| 70 | 600 | 261.36 |
| 70 | 700 | 269.3438 |
| 70 | 800 | 276.48 |
| 90 | 200 | 413.1 |
| 90 | 300 | 437.6353 |
| 90 | 400 | 460.768 |
| 90 | 500 | 482.5238 |
| 90 | 600 | 502.928 |
| 90 | 700 | 522.0063 |
| 90 | 800 | 539.784 |

The input/output relationship for the object to be controlled is identified using the multivariate analysis method using the data that has been collected. The explanation will be for the use of a method that uses fuzzy quantification logic 2 in the present form of embodiment as well. When the method that uses the fuzzy quantification theory 2 is applied to the data of Table 4, an electric power estimating function equation such as shown below is obtained. Note that here a fourth-order approximation is used.

$$\begin{matrix} S = - 0.072736 + 0.005958 \times MV + 0.000066 \times PV & ( 9 ) \\ U\_est = 3.24569 - 135.491825 \times S + 2785.834284 \times S 2 - 4273.532557 \times S 3 + 6276.490677 \times S 4 & ( 10 )\end{matrix}$$

Table 5 shows the data of Table 4, collected in advance, and the electric power estimate value U_est obtained when the Table 4 manipulated variable MV and produced variable PV were inputted into the electric power estimating function equations of Equation (4) and Equation (10). Additionally, while Table 5 is a comparison using the data gathered for producing the formula, Table 8 shows other data that was collected separately for validating the formula (other hypothetical data obtained from Equation (7) and Equation (6)), and the electric power estimate values U_est obtained when this data was inputted into the electric power estimating function equation.

TABLE 5

| MV | PV | U | U_est |
|---|---|---|---|
| 10 | 200 | 2.7 | 3.239734 |
| 10 | 300 | 2.36925 | 2.467216 |
| 10 | 400 | 2.016 | 1.930147 |
| 10 | 500 | 1.65375 | 1.621587 |
| 10 | 600 | 1.296 | 1.53488 |
| 10 | 700 | 0.95625 | 1.663657 |
| 10 | 800 | 0.648 | 2.001835 |
| 30 | 200 | 29.7 | 20.70872 |
| 30 | 300 | 30.06575 | 23.354 |
| 30 | 400 | 30.184 | 26.15343 |
| 30 | 500 | 30.07125 | 29.10521 |
| 30 | 600 | 29.744 | 32.20785 |
| 30 | 700 | 29.21875 | 35.46014 |
| 30 | 800 | 28.512 | 38.86116 |
| 50 | 200 | 97.5 | 91.61764 |
| 50 | 300 | 101.4423 | 97.00714 |
| 50 | 400 | 104.832 | 102.5626 |
| 50 | 500 | 107.6888 | 108.2875 |
| 50 | 600 | 110.032 | 114.1854 |
| 50 | 700 | 111.8813 | 120.2603 |
| 50 | 800 | 113.256 | 126.5164 |
| 70 | 200 | 220.5 | 218.1493 |
| 70 | 300 | 232.0988 | 227.2915 |
| 70 | 400 | 242.76 | 236.7048 |
| 70 | 500 | 252.5063 | 246.3977 |
| 70 | 600 | 261.36 | 256.3789 |
| 70 | 700 | 269.3438 | 266.6577 |
| 70 | 800 | 276.48 | 277.2433 |
| 90 | 200 | 413.1 | 432.8567 |
| 90 | 300 | 437.6353 | 448.4425 |
| 90 | 400 | 460.768 | 464.4974 |
| 90 | 500 | 482.5238 | 481.0353 |
| 90 | 600 | 502.928 | 498.0701 |
| 90 | 700 | 522.0063 | 515.616 |
| 90 | 800 | 539.784 | 533.6877 |

TABLE 6

| MV | PV | U | U_est |
|---|---|---|---|
| 20 | 200 | 12 | 4.244312 |
| 20 | 300 | 11.7325 | 5.370029 |
| 20 | 400 | 11.34 | 6.678893 |
| 20 | 500 | 10.8375 | 8.166543 |
| 20 | 600 | 1024 | 9.828903 |
| 20 | 700 | 9.5625 | 11.66219 |
| 20 | 800 | 8.82 | 13.66289 |
| 40 | 200 | 57.6 | 5005857 |
| 40 | 300 | 59.319 | 54.05503 |
| 40 | 400 | 60.648 | 58.19991 |
| 40 | 500 | 61.605 | 62.494 |
| 40 | 600 | 62.208 | 66.9384 |
| 40 | 700 | 62.475 | 71.53448 |
| 40 | 800 | 62.424 | 76.28388 |
| 60 | 200 | 151.2 | 146.6078 |
| 60 | 300 | 158.3855 | 153.6425 |
| 60 | 400 | 164.836 | 160.8841 |
| 60 | 500 | 170.5725 | 168.3384 |
| 60 | 600 | 175.616 | 176.0119 |
| 60 | 700 | 179.9875 | 183.9109 |
| 60 | 800 | 183.708 | 192.0424 |
| 80 | 200 | 307.2 | 311.2601 |
| 80 | 300 | 324.532 | 323.1826 |
| 80 | 400 | 340.704 | 335.4636 |
| 80 | 500 | 355.74 | 348.1142 |
| 80 | 600 | 369.664 | 361.1458 |
| 80 | 700 | 382.5 | 374.5701 |
| 80 | 800 | 394.272 | 388.3991 |

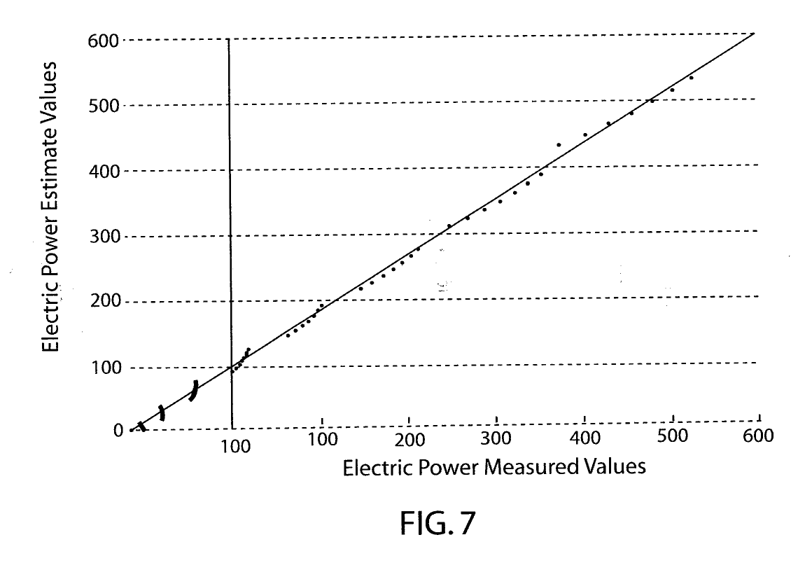

FIG. 7 shows a graph wherein the electric power measured values U, shown in Table 5 and Table 6 are graphed on the horizontal axis, and the electric power estimated values U_est are graphed on the vertical axis. While the collected data illustrated in Table 5 and Table 6 are hypothetical data for illustrating roughly the degree of accuracy that can be obtained for the electric power estimate values, it can be seen that the accuracy of the electric power estimate values is increased through using the manipulated variable MV and the produced variable PV as input variables.

In the case of actually calculating the electric power estimating function equation, the manipulated variables MV, the produced variables PV, and the electric power measurement values U may be actually measured for the object to be measured, and with manipulated variable MV and the produced variable PV as the input variables and the electric power estimate values U_est as the output variable, multivariate analysis may be performed using the actual data for the manipulated variables MV and the produced variables PV, and the actual measured data for the electric power measured values U.Additionally, the calculated electric power estimating function equation may be set into the electric power estimating unit Sa.

In this way, in the present form of embodiment, the electric power consumed by the heater is estimated by the electric power estimating function equation using the manipulated variable MV and the produced variable PV as the input variables, enabling the temperature dependency of the heater resistance to be corrected by the produced variable PV, thus making it possible to estimate the instantaneous electric power consumption of the heater with excellent accuracy. Additionally, because in the present form of embodiment the produced variable PV is obtained using the existing temperature sensor that is provided in the control device, it is possible to estimate the instantaneous electric power consumption of the heater without adding any special equipment. Additionally, because the instantaneous electric power consumption estimate value for the heater can be calculated without measuring the electric current value CT, this can be applied to a control device that is not provided with an electric current measuring unit.

Note that while in the above embodiments the explanation used a method that uses the fuzzy classification method 2, but any multivariate analysis system approximation formula generating method, such as SVR (Support Vector Regression) or multiple regression analysis may be applied to the present invention.

The control devices explained above can be embodied by a computer that is provided with a CPU, a memory device, and an interface, and by a program for controlling the hardware resources thereof. The CPU executes the processes explained in the embodiments in accordance with a program that is stored in the memory device.

The present invention can be applied to a control device such as a temperature controller.

1. A control device comprising:
control calculating device, and outputting to an actuator, manipulated variable MV based on a produced variable PV to be controlled; and
electric power estimating device estimating electric power consumption of the actuator using an electric power estimating function equation established in advance, having, as input variables, the produced variable PV and an electric current value CT for the electric current that flows through the actuator in accordance with the electric power of the manipulated variable MV.

2. A control device as set forth in claim 1, wherein:
the electric power estimating device estimate the electric power consumption of the actuator with the manipulated variable MV as an input variable in addition to the electric current value CT and the produced variable PV.

3. A control device comprising:
control calculating device calculating, and outputting to an actuator, an manipulated variable MV based on a produced variable PV to be controlled; and
electric power estimating device estimating the electric power consumption of the actuator using an electric power estimating function equation established in advance, having, as input variables, the manipulated variable MV and the produced variable PV.

4. A control device as set forth in claim 1, wherein:
the electric power estimating function equation is derived in advance through multivariate analysis from actual measured data for power consumption of the actuator and actual measured data for the input variables.

5. An electric power estimating method comprising the steps of:
calculating, and outputting to an actuator, manipulated variable MV based on a produced variable PV to be controlled; and
estimating electric power consumption of the actuator using an electric power estimating function equation established in advance, having, as input variables, the produced variable PV and an electric current value CT for the electric current that flows through the actuator in accordance with the electric power of the manipulated variable MV.

6. An electric power estimating method as set forth in claim 5, wherein:
estimating the electric power consumption of the actuator with the manipulated variable MV as an input variable in addition to the electric current value CT and the produced variable PV.

7. An electric power estimating method comprising the steps of:
calculating, and outputting to an actuator, an manipulated variable MV based on a produced variable PV to be controlled; and
estimating the electric power consumption of the actuator using an electric power estimating function equation established in advance, having, as input variables, the manipulated variable MV and the produced variable PV.
